(19) United States
(12) Patent Application Publication
(10) Pub. No.: US 2004/0095871 A1
(43) Pub. Date: May 20, 2004

(54) Optical pickup device

(76) Inventor: Hiroyuki Shindo, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/633,683

(22) Filed: Aug. 5, 2003

(30) Foreign Application Priority Data
Aug. 7, 2002 (JP) 2002-230065

(51) Int. Cl. G11B 7/135

(52) U.S. Cl. 369/112.21; 369/112.28

(57) ABSTRACT

An optical pickup device as integrated into a disk device which drives optical disks is described. To provide a highly-reliable optical pickup device: without attenuation of the power of the laser beam used to form a laser spot on the optical disk, accurately monitoring the amount of light emission from the semiconductor laser element, and unaffected by the nonuniform reflectance and permeability of the reflection film and by variations in environmental conditions such as temperature and humidity. Using an optical pickup device which records and replays information by making a laser beam emitted from a first semiconductor laser element 1a incident upon a recording medium D via a shaping prism 5; a portion of the peripheral rays L1 of the laser beam incident upon the shaping prism 5 is incident upon the outer wall 5c of the shaping prism, and the reflected light thereof is guided to a light-receiving element 6; and the output of light emitted from the first semiconductor laser element 1a is controlled in accordance with the output signal of the light-receiving element.

### BACKGROUND OF THE INVENTION

1. Field of the Invention

The present invention relates to improvements in an optical pickup device which is incorporated into a disk device for driving an optical disk such as compact disk (CD) or digital versatile disk (DVD) served as a recording medium in a computer system or audio system, and which records information to, or replays information from this recording medium.

2. Detailed Description of the Prior Art

In general, a semiconductor laser element is used to generate laser beam for an optical pickup device in a disk device; however, it is known that the light emission amount of a semiconductor laser element varies with the environmental temperature, aging and other similar factors. If the light emission amount of the semiconductor laser element varies with these factors, it deteriorates the reliability of the system. Therefore, usually the amount of the light emission is kept constant by monitoring itself through a front monitoring method and executing a feedback control through Auto Power Control (APC) circuit.

FIG. 2 shows an example of a conventional design featuring a front monitoring method, and in the figure, a laser beam emitted from a semiconductor laser element 101 turns into parallel light by a collimator lens 102 to be incident upon a beam splitter 104 via a grating 103.

The beam splitter 104 permeates approximately 90% of the laser beam emitted from the semiconductor laser element 101, and is equipped with a reflecting film 105 to reflect the rest of the beam of approximately 10%. The approximate 90% laser beam which was penr ated through the beam splitter 104 is subsequently permeated through a quarter-wave plate 106 and is condensed by an objective lens 107 to form a beam spot on the recording surface of an optical disk D. The reflected light from the beam spot is reflected by the reflecting film 105 of the beam splitter 104 through the objective lens 107 and the quarter-wave plate 106, and then it is incident upon a detector 109 by being condensed by the condenser lens 108.

Meanwhile, the approximate 10% laser beam reflected on the reflecting film 105 of the beam splitter 104 is incident upon a light-receiving element 111 by being condensed by a condenser lens 110, and then the light-receiving element outputs an electrical signal to an APC circuit 112 in accordance with the amount of incident light thereof. The APC circuit 112 is designed to send an output controlled by the electrical signal to the semiconductor laser element 101. Therefore, even if the amount of light emitted from the semiconductor laser element 101 increases or decreases with respect to a standard value affected by factors such as changes in environmental temperature, this variation is compensated and a fixed light emission amount is obtained.

FIG. 3 shows another constitutional example of a conventional front monitoring method, and as shown in the figure, a laser beam emitted from a semiconductor laser element 201 is paralleled by a collimator lens 202 to be incident upon an incidence face 204a of a shaping prism 204 through a grating 203.

The laser beam which is permeated through the incidence face 204a is further permeated through a reflecting film 204b to be guided to a quarter-wave plate 205, and is then guided to an objective lens 207 by a reflecting prism 206. Furthermore, the laser beam is condensed by the objective lens 207 to form a beam spot on the recording surface of an optical disk D.

Following this, the reflected light from the beam spot is reflect d by the reflecting film 204b of the shaping prism 204 via the objective lens 207 and the quarter-wave plate 205, then it is incident upon a detector 210 via a condensing lens 208 and a multi-lens 209.

Meanwhile, a portion of the laser beam reflected by the reflecting face 204a of the shaping prism 204 is irradiated upon a light-receiving element 211 for outputting an electrical signal to an APC circuit 212 in accordance with the amount of incident light thereof. The APC circuit 212 is designed so as to send an output controlled in accordance with the electrical signal to the semiconductor laser element 201. Therefore, even if the amount of light emitted from the semiconductor laser element 201 increases or decreases with respect to a standard value affected by factors such as changes in environmental temperature, this variation is compensated and a fixed light emission amount is obtained.

When applying the conventional front monitoring system thereto as described above, a portion of the laser beam emitted from the semiconductor laser element is guided to the light-receiving element by the reflecting film. Therefore, the attenuation of the laser power delivered to the optical disk causes a problem to reduce the utilization of the system. Moreover, as the reflecting film is formed with non-uniform reflectance and permeability, and they vary depending on changes in environmental conditions such as temperature and humidity, difficulty has been experienced with regard to improving reliability.

### SUMMARY OF THE INVENTION

Taking the abovedescribed problems into consideration, the present invention aims to enable the output of light emitted from a semiconductor laser element to be monitored without attenuation of the laser power to be delivered to an optical disk, and furthermore, without using a reflecting film. In accordance with this, the object of the present invention is to provide a highly-reliable optical pickup device which may be easily designed and adjusted.

The optical pickup device according to the present invention is characterized in that a laser beam emitted from a first semiconductor laser element is made incident upon a recording medium via a shaping prism so that information may be recorded or replayed. Furthermore, a portion of the peripheral rays of the laser beam incident upon the shaping prism is incident upon the outer wall of the shaping prism, the reflected light thereof is guided to a light-receiving element, and the output of light emitted from the first semiconductor laser element is controlled in accordance with the output signal from the light-receiving element. Thus, the above-mentioned problem is solved.

Furthermore, the optical pickup device according to the present invention provides a reflection means (4) whereby the laser beam emitted from the first semiconductor laser element is reflected and guided to a shaping prism arranging the light-receiving element adjacent to the reflection means. Thus, the above-mentioned problem is solved.

The optical pickup device of the present invention also provides a second semiconductor laser element; enabling to execute recording or replaying of information not only by making the laser beam emitted from the first semiconductor laser element incident upon the recording medium via the shaping prism but also by making the laser beam emitted from the second semiconductor laser element incident upon the recording medium via the shaping prism. Thus, the above-mentioned problem is solved.

The optical pickup device of the present invention also utilizes the first semiconductor laser element when recording information to, or replaying information from a high-density recording disk, and utilizes the second semiconductor laser element when recording information to, or replaying information from a low-density recording disk. Thus, the above-mentioned problem is solved.

In addition, the optical pickup device of the present invention is characterized in that the shaping prism has an incidence portion in which the laser beam emitted from the first semiconductor laser element is incident and a reflection portion which reflects the laser beam emitted from the second semiconductor laser element A portion of the peripheral rays of the laser beam is reflected at the outer wall between the incidence portion and the reflection portion of the shaping prism and the reflected light thereof is guided to the light-receiving element. Thus, the above-mentioned problem is solved.

Furthermore, the optical pickup device according to the present invention is characterized in that it provides a reflection means (4) whereby the laser beam emitted from the first semiconductor laser element is reflected and guided to a shaping prism. The laser beam emitted from the first semiconductor laser element forms a V-shaped locus by being reflected through the reflection means (4) to reach the shaping prism; and of the small angle and large angle specified for the laser beam's V-shaped locus, the light-receiving element is positioned on the same side as the large angle.

### BRIEF DESCRIPTION OF THE DRAWINGS

FIG. 1 is a block diagram showing a schematic view of an optical pickup device according to the present invention.

FIG. 2 is a block diagram showing an example of an optical pickup device known in the prior art.

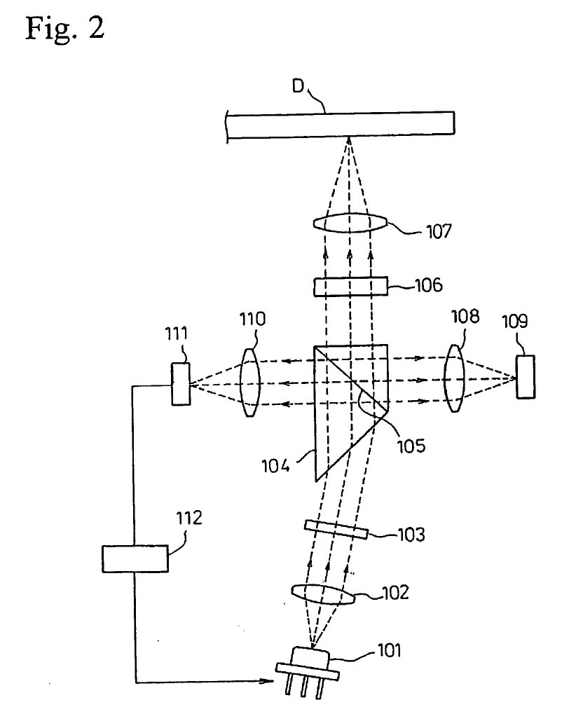

FIG. 3 is a block diagram showing another example of an optical pickup device known in the prior art.

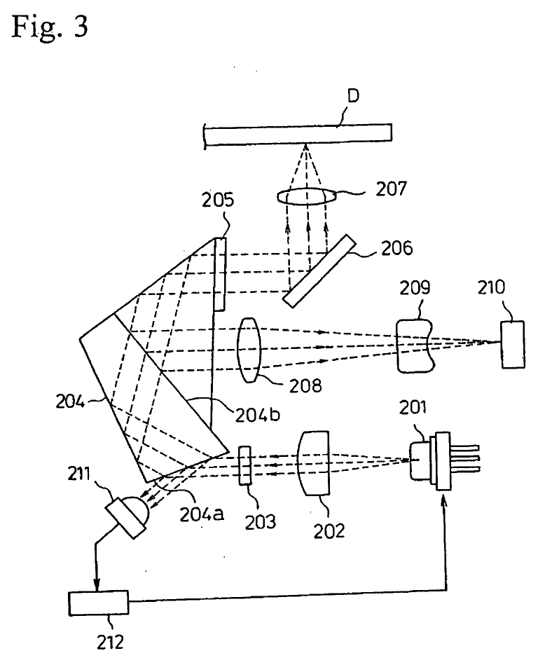

### EXPLANATION OF THE REFERENCES

1: Laser unit

2: Quarter-wave plate

3: Collimator lens

4: Reflecting prism

5: Shaping prism

6: Light-receiving element

7: APC circuit

9: Objective lens

10: Condenser lens

11: Reflecting prism

12: Laser unit

D: Optical disk

L1: Peripheral rays

### DETAILED DESCRIPTION OF THE PREFERRED EMBODIMENT

In the following, an embodiment of the present invention is described with reference to the drawings. In addition, the optical pickup device according to the following embodiment has multiple light sources of different wavelengths and is constructed so as to respond both to a high-density optical disk such as DVD-ROM or DVD-R and to a standard optical disk (low-density optical disk) such as CD or CD-ROM.

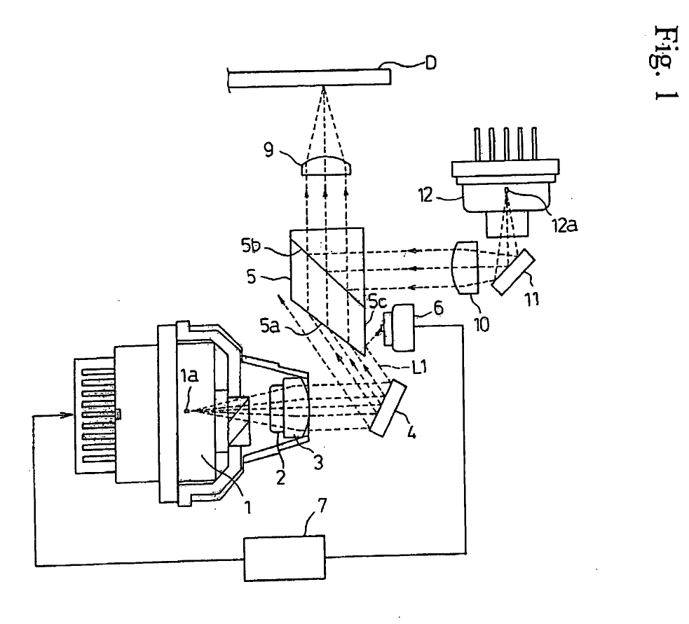

FIG. 1 shows a schematic view of the present invention. In the figure, Reference 1 indicates a first laser unit comprising a first semiconductor laser element 1a, a detector, a hologram element, and a prism. The Reference 1 corresponds to a high-density optical disk (such as DVD). Reference 2 indicates a quarter-wave plate, and Reference 3 indicates a collimator lens. Reference 4 is a reflecting prism which reflects the paralleled laser beam incident from the collimator lens 3 to a shaping prism 5, and the reflected light thereof is incident upon both an incidence face 5a of the shaping prism 5 and a light-receiving element 6 positioned so as to oppose the side wall of the shaping prism 5.

Furthermore, an anti-reflection (AR) coating is provided to the incidence face 5a of the shaping prism 5, so that the incident laser beam is actively prevented from reflecting.

An electrical signal in accordance with the amount of incident light is output from the light-receiving element 6 to the APC circuit 7, and an output controlled in accordance with the electrical signal is sent to the first semiconductor laser element 1a. In other words, the detected electrical signal of the light-receiving element 6 is compared with a preset standard value in the APC circuit 7, and when an error occurs, drive of the first semiconductor laser element 1a is controlled in accordance with the magnitude of the error, so that the power of the laser beam may be fixed.

Furthermore, the laser beam incident upon the shaping prism 5 is permeated through a reflecting film 5b and guided to an objective lens 9. Then the laser beam is condensed by the objective lens 9 to form a beam spot on the recording surface of an optical disk D. The reflected light from the beam spot is permeated through the objective lens 9 and the shaping prism 5, and after being reflected by the reflecting prism 4, it is permeated through the collimator lens 3 and the quarter-wave plate 2 to be incident upon a detector within the laser unit 1.

By the optical pickup device of the present invention as constructed above, rays in the central area of laser beam emitted from the semiconductor laser element 1a of the first laser unit 1 are all incident upon the shaping prism 5 via the incidence face 5a thereof, and following this, trace the above-mentioned optical locus. Meanwhile, a portion of the laser beam's peripheral rays L1 is incident upon a reflecting surface 5c formed on the outer surface of the shaping prism 5, and the reflected light thereof is incident upon the light-receiving element 6. In accordance with the amount of the light of the peripheral rays L1, the light-receiving element 6 outputs an electrical signal to the APC circuit 7, and drives and controls the first semiconductor laser element 1a.

Furthermore, Reference 12 indicates a second laser unit comprising a second semiconductor laser element 12a, a detector, a hologram element, and a prism. The reference 12 also corresponds to a standard optical disk (low-density optical disk) such as CD. Reference 11 indicates a shaping prism, and Reference 10 indicates a collimator lens. The laser beam emitted from the second laser unit 12 and incident upon the shaping prism 6 is reflected by the reflecting film 5b and guided to the objective lens 9. The laser beam is condensed by the objective lens 9 to form a beam spot on the recording surface of the optical disk D. The reflected light from the beam spot is reflected by the reflecting film 5b of the shaping prism 5 via the objective lens 9, permeating through the collimator lens 10, and after being reflected by the reflecting prism 11, it is incident upon a detector within the laser unit 12.

As shown above, It is clear there is no attenuation of beam power in the present invention, because all of the dominant laser beams for formation of a beam spot on the recording surface of an optical disk are arranged to be incident upon the shaping prism.

Meanwhile, since peripheral rays from the semiconductor laser element without using reflected light from the reflecting film are made directly incident upon the light-receiving element which monitors the amount of light emission from the semiconductor laser element, the corresponding condition can be ascertained with extreme accuracy. Furthermore, the optical pickup device has the advantage of high levels of reliability without being affected by the reflecting film's non-uniform reflectance and permeability or by variations in environmental conditions such as temperature and humidity.

What is claimed is:

1. An optical pickup device, in which a laser beam emitted from a first semiconductor laser element is incident upon a recording medium via a shaping prism in order to record or replay information, characterized in that:
a portion of the peripheral rays emitted from the laser beam to be incident upon the shaping prism is incident upon the outer wall of the shaping prism, the reflected light thereof is guided into a light-receiving element, and the output of light emitted from the first semiconductor laser element is controlled in accordance with the output signal of said light-receiving element.

2. The optical pickup device of claim 1, further comprising a reflection means (4) for making the laser beam emitted from the first semiconductor laser element reflect and guiding to the shaping prism; characterized in that said light-receiving element is arranged adjacent to said reflection means.

3. The optical pickup device of claim 1, further comprising an second semiconductor laser element, characterized in that record or replay of information is carried out by making the laser beam emitted from said first semiconductor laser element incident upon the recording medium via said shaping prism; and record or replay of information is carried out by making the laser beam emitted from said second semiconductor laser element incident upon the recording medium via said shaping prism.

4. The optical pickup device of claim 3, further characterized in that:
the first semiconductor laser element is utilized when recording information to, or replaying information from a high-density recording disk; and
the second semiconductor laser element is utilized when recording information to, or replaying information from a low-density recording disk.

5. The optical pickup device of claim 3, said shaping prism further having an incidence portion on which the laser beam emitted from the first semiconductor laser element is incident and a reflection portion whereby the laser beam emitted from the second semiconductor laser element is reflected:
characterized in that a portion of the peripheral rays of the laser beam is reflected at the outer wall between said incidence portion and said reflection portion; and
the reflected light thereof is guided to the light-receiving element.

6. The optical pickup device of claim 1, further characterized in that:
a reflection means (4) is provided whereby the laser beam emitted from the first semiconductor laser element is reflected and guided to the shaping prism; the laser beam emitted from the first semiconductor laser element forms a V-shaped locus by being reflected through the reflection means (4) to reach the shaping prism; and of the small angle and large angle specified for said laser beam's V-shaped locus, said light-receiving element is positioned on the same side as the large angle.
